(19) United States
(12) Patent Application Publication
(10) Pub. No.: US 2002/0196477 A1
(43) Pub. Date: Dec. 26, 2002

(54) Scanner with wireless connections

(76) Inventor: Michael Chen, Hsinchu (TW)

Correspondence Address: NAIPO (NORTH AMERICA INTERNATIONAL PATENT OFFICE), P.O. BOX 506, MERRIFIELD, VA, 22116, US

(21) Appl. No.: 09/885,039

(22) Filed: Jun. 21, 2001

(51) Int. Cl. H04N 1/04

(52) U.S. Cl. 358/474

(57) ABSTRACT

A scanner that can connect wirelessly with at least one external device. The scanner has a housing, a transparent plate for supporting a document to be scanned, a scanning module in the housing, and control circuitry for controlling operations of the scanning module. The external device has a display panel for displaying data and information, and a control panel for controlling operations of the external device. By use of wireless technology, the external device is able to control operations of the scanner to scan, print, fax, or send information over a local area network.

### BACKGROUND OF THE INVENTION

1. Field of the Invention

The present invention relates to a scanner, and more particularly, to a scanner that can establish a wireless connection with at least one external device.

2. Description of the Prior Art

Scanners are very common peripherals used in home and office computing. Scanners can convert a physical document, typed on paper or other physical media, into a digital format that can be edited on, or printed from, a computer. Scanners can also be used to convert images from some physical medium, such as photographic paper or film, into a digital format that can be manipulated on the computer. Applications for scanners range from creating digital databases from records dating back before computers were universal, to putting real estate listings on the Internet. By adding special communications software, most scanners can even be converted into fax machines.

Please refer to FIGS. 1-2, which are perspective and rear views of a scanner 10, according to the prior art. To scan content and send the content directly to the Internet or a personal data assistant (PDA), the scanner 10 comprises a plurality of control buttons 12. To accommodate the many other functions of the scanner, as listed above, the scanner 10 also has a plurality of LPT ports 13, a plurality of USB connections 14, and phone, ADSL, or high-speed Local Area Network (LAN) connections 16.

Typically, scanning may be performed in two ways. A first way is to send a command to the scanner 10 from a computer through a graphical user interface. Most graphics editing programs have access to the graphical user interface for the scanner 10. The computer may be directly connected to the scanner 10 by one of the LPT ports 13, one of the USB connections 14, or in directly connected through the LAN connections 16. A second way of performing a scan is to push one of the control buttons 12 of the scanner 10. The control buttons can control the scanner 10 to send scanned content to a web server or to a local device, such as a PDA connected by cable to the scanner 10.

If all of the connections to the scanner 10 use physical wiring, in the form of cables and phone lines, an area around the scanner quickly becomes a veritable jungle of wires. If one of the wires is too short, the scanner 10 may only have an inch or two of play, making relocation of the scanner 10 a time-consuming task. If many of the wires are long, the wires can easily become tangled, again limiting mobility of the scanner 10. When troubleshooting, or operating directly on the scanner 10, an operator may have to unplug and replug some or all of the connected wires. Additionally, to connect a portable device, such as a PDA, wiring the device by cable to the scanner 10 seems overly troublesome.

### SUMMARY OF THE INVENTION

It is therefore a primary objective of the present invention to provide a scanner that can connect wirelessly with one or more external devices.

According to the claimed invention, briefly summarized, the scanner has means to wirelessly connect to a plurality of external devices. The external devices can be used to control operation of the scanner, and view responses from the scanner. Moreover, the scanner can also be wirelessly connected to a LAN, PDA, cell phone, printer, fax/modem, or other such device.

It is an advantage of the present invention that the scanner can connect wirelessly to external devices, allowing for easy transport, and use of remote control.

These and other objectives of the present invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1 is a perspective view of a prior art scanner.

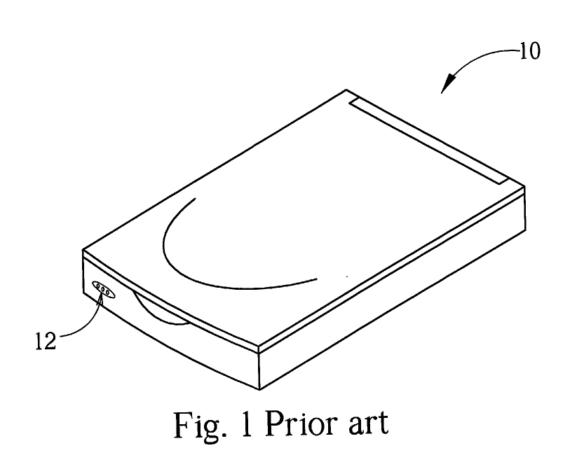

FIG. 2 is a rear view of the scanner of FIG. 1.

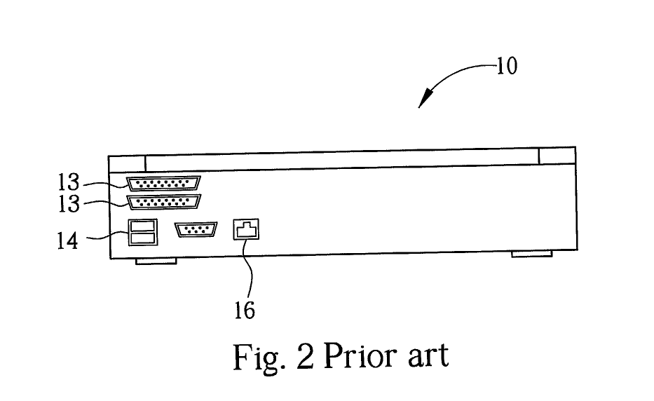

FIG. 3 is a perspective diagram of a scanner, according to the present invention, and an external device.

### DETAILED DESCRIPTION OF THE PREFERRED EMBODIMENT

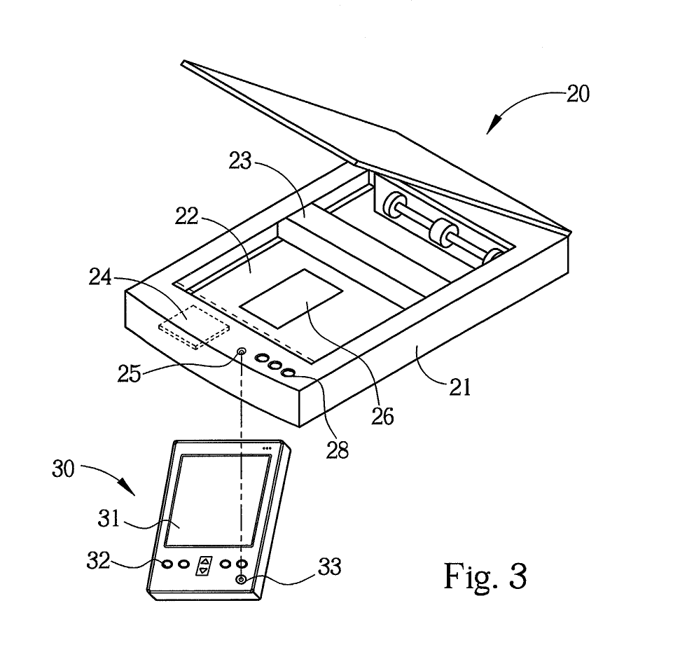

Please refer to FIG. 3. FIG. 3 is a perspective diagram of a scanner 20 and a personal data assistant (PDA) 30 acting as an external device, according to the present invention. The scanner 20 comprises a housing 21, a plurality of control buttons 28 positioned on the housing, a transparent platform 22 for a document 26 to be placed on, a scanning module 23 that is positioned inside the housing for scanning the document 26, control circuitry 24 that controls operations of the scanning module 23, and a transceiver 25 using a Bluetooth protocol. The PDA 30 comprises a display panel 31 for displaying data and information, a control panel 32 for controlling functionality of the PDA 30, and a transceiver 33 using the Bluetooth protocol. The PDA 30 is wirelessly connected to the scanner 20 by sending radio signals through the transceivers 25, 33 of the scanner 20 and the PDA 30.

The scanner 20 is capable of a third control method, which is enabled through use of the PDA 30. The control panel 32 of the PDA 30 can be used to control the scanner 20, without the PDA 30 being physically connected to the scanner 20. The PDA 30 downloads a scanner control program, which enables the PDA 30 to display a graphical user interface that has buttons to control operations of the scanner 20. Through use of the control panel 32, touching the buttons on the control panel 32 causes the transceiver 33 to send wireless radio signals to the scanner 20. The scanner 20 receives the signals through the transceiver 25. For a case of the signal being a command to scan, the scanner 20 can send data from the scan back to the PDA 30, again through use of the Bluetooth protocol. The PDA 30 then displays a preview of the scanned content on the display panel 31. The control panel 32 of the PDA 30 then has controls for selecting an area to scan, a color depth, a resolution, or any other feature common to the control interface for the scanner 20. The scanner 20 and the PDA 30 are also capable of exchanging user identification information to enable security measures when logging onto the scanner 20. Additionally, the PDA 30 is capable of sending email addresses or phone numbers, so that the scanned content may be sent by email or fax via the scanner 20.

As the scanner 20, being a scanner server, can connect to the Internet, the PDA 30 can also be used to browse the Internet, or to connect to the scanner 20 for e-mail access. This saves connection fees, not to mention time and effort that are wasted repeatedly typing e-mail addresses and telephone numbers.

Though the above example is described for the case of the scanner 20 being connected with the PDA as the external device 30, both devices being equipped with Bluetooth technology, it should be obvious to one skilled in the art that any external device 30 having a display screen and a control panel (such as a cellular phone, or a notebook computer) complies with requirements of the present invention. Additionally, please note that although the above example introduces use of Bluetooth technology, any technology that offers wireless transmission and reception of data signals complies with the present invention. Though infrared technology produces the effect of the present invention, Bluetooth is chosen for having characteristically high transfer rates, and relative ease of integration and use. Bluetooth is also capable of slaving up to 9 other devices.

Moreover, the scanner 20 can be connected wirelessly with other external devices that have transceivers utilizing the Bluetooth protocol. The other external devices may include, but are not limited to, printers, local area networks (LAN), and fax machines. Through use of wireless technology, the PDA 30 can send a data stream to be printed by a printer, faxed, or sent over the LAN, via the scanner 20. The data stream is not necessarily limited to scanned data. First sending a document file stored in the PDA 30 to the scanner 20, then utilizing the document file as the data stream, also accomplishes the object of the present invention.

Compared with the prior art, the scanner 20, by using wireless technology, reduces a number of wires connected to the scanner 20, allows for remote control, and offers great versatility in operator security and information transfer.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A scanner capable of establishing a wireless connection with at least one external device, the scanner comprising:
a housing;
a transparent platform for a document to be placed on;
a scanning module installed inside the housing for scanning the document; and
control circuitry for controlling operations of the scanning module;
the external device comprising:
a display panel for displaying data and information; and
a control panel for controlling functionality of the external device;
wherein a user is capable of using the control panel of the external device to remotely control functionality of the scanner and using the display panel of the external device to view responses from the scanner.

2. The scanner of claim 1 further comprising a transceiver, wherein the external device further comprises a transceiver, the scanner and the external device using their respective transceivers to send radio signals to each other, or to receive radio signals from each other.

3. The scanner of claim 2 wherein the scanner and the external device both use a Bluetooth protocol to send and receive the radio signals.

4. The scanner of claim 2 wherein the transceivers are infrared transceivers, the scanner and the external device using their respective infrared transceivers to send radio signals to each other, or to receive radio signals from each other.

5. The scanner of claim 1 wherein when the scanner is connected to a peripheral device, the external device is capable of controlling the scanner to output data using the peripheral device.

6. The scanner of claim 5 wherein the scanner is capable of establishing a wireless connection with the peripheral device.

7. The scanner of claim 6 further comprising a transceiver, wherein the peripheral device further comprises a transceiver, the scanner and the peripheral device using their respective transceivers to send radio signals to each other, or to receive radio signals from each other.

8. The scanner of claim 7 wherein the scanner and the peripheral device both use a Bluetooth protocol to send and receive the radio signals.

9. The scanner of claim 7 wherein the transceivers are infrared transceivers, the scanner and the peripheral device using their respective infrared transceivers to send radio signals to each other, or to receive radio signals from each other.

10. The scanner of claim 5 wherein the peripheral device is a printer, and the external device is capable of controlling the scanner to print the document using the printer.

11. The scanner of claim 1 wherein when the scanner is connected to a network, the external device is capable of sending information to the network via the scanner.

12. The scanner of claim 11 wherein the external device is capable of sending faxes or e-mail messages to the network via the scanner.

13. The scanner of claim 11 wherein the network is internet or intranet.

14. The scanner of claim 11 further comprising a transceiver, wherein the network further comprises a transceiver, the scanner and the network using their respective transceivers to send radio signals to each other, or to receive radio signals from each other.

15. The scanner of claim 14 wherein the scanner and the network both use a Bluetooth protocol to send and receive the radio signals.

16. The scanner of claim 14 wherein the transceivers are infrared transceivers, the scanner and the network using their respective infrared transceivers to send radio signals to each other, or to receive radio signals from each other.

17. The scanner of claim 1 wherein the scanner will compare an ID (identification) code of the external device with ID codes stored in the scanner to determine if the external device is allowed to log onto the scanner.

18. The scanner of claim 1 wherein the external device is a cellular phone.

19. The scanner of claim 1 wherein the external device is a personal data assistant (PDA).

20. The scanner of claim 1 wherein the external device is a notebook.
